(19) United States
(12) Patent Application Publication
(10) Pub. No.: US 2026/0269373 A1
(43) Pub. Date: Sep. 10, 2026

(54) PACKAGABLE MULTI-LAYERED THERMAL BARRIER ASSEMBLIES FOR TRACTION BATTERY CELL STACKS

(71) Applicant: FORD GLOBAL TECHNOLOGIES, LLC, Dearborn, MI (US)

(72) Inventors: Mihir Devendra UPADHYE, Livonia, MI (US); Sangyeon KIM, Northville, MI (US); Jie DENG, Novi, MI (US)

(21) Appl. No.: 19/258,065

(22) Filed: Jul. 2, 2025

Related U.S. Application Data
(60) Provisional application No. 63/766,623, filed on Mar. 4, 2025.

(51) Int. Cl. H01M 10/658; B60L 50/64; H01M 10/613; H01M 10/625; H01M 10/647; H01M 10/6551; H01M 10/656; H01M 50/211; H01M 50/249; H01M 50/293

(52) U.S. Cl. CPC H01M 10/658; H01M 10/613; H01M 10/625; H01M 10/647; H01M 10/6551; H01M 10/656; H01M 50/211; H01M 50/249; H01M 50/293; B60L 50/64; H01M 2220/20

(57) ABSTRACT

Thermal barrier assembly designs are provided for use within traction battery packs. An exemplary traction battery pack may include a battery array having a cell stack housed within an array housing. The cell stack may include one or more thermal barrier assemblies arranged between adjacent battery cells of the cell stack. Each thermal barrier assembly may include a thermal fin and a thermal resistance material insert received within a void space of the thermal fin, thereby increasing the amount of thermal insulation across a conduction path of the cell stack without increasing the overall thickness of the thermal barrier assembly. A surface area ratio of the insert relative to the thermal fin can be tuned to balance the respective amounts of thermal insulation and thermal conductivity provided by the thermal barrier assembly.

### CROSS-REFERENCE TO RELATED APPLICATIONS

This disclosure claims the benefit of U.S. Provisional Application No. 63/766,623, which was filed on Mar. 4, 2025 and is incorporated herein by reference in its entirety.

### TECHNICAL FIELD

This disclosure relates generally to electrified vehicle traction battery packs, and more particularly to insulating and packageable multi-layered thermal barrier assemblies for use within battery cell stacks of traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first battery cell, a second battery cell, and a thermal barrier assembly arranged between the first battery cell and the second battery cell. The thermal barrier assembly includes a thermal fin and a thermal insulating material insert received within a void space of the thermal fin.

In a further non-limiting embodiment of the foregoing traction battery pack, the first battery cell, the second battery cell, and the thermal barrier assembly are housed inside a housing that includes a top cover and a bottom cover.

In a further non-limiting embodiment of either of the foregoing traction battery packs, an upper fin portion of the thermal fin is fixedly secured to the top cover by an adhesive.

In a further non-limiting embodiment of any of the foregoing traction battery packs, a lower fin portion of the thermal fin is fixedly secured to the bottom cover by an adhesive.

In a further non-limiting embodiment of any of the foregoing traction battery packs, the thermal barrier assembly separates a first compartment where the first battery cell resides from a second compartment where the second battery cell resides.

In a further non-limiting embodiment of any of the foregoing traction battery packs, the first compartment and the second compartment establish separate coolant flow passages for receiving an immersion coolant.

In a further non-limiting embodiment of any of the foregoing traction battery packs, the thermal insulating material insert is a mica insert.

In a further non-limiting embodiment of any of the foregoing traction battery packs, the thermal insulating material insert fills the void space of the thermal fin.

In a further non-limiting embodiment of any of the foregoing traction battery packs, the thermal fin is sandwiched between a first thermal resistance material layer and a second thermal resistance material layer.

In a further non-limiting embodiment of any of the foregoing traction battery packs, a first stepped section of the first thermal resistance material layer and a second stepped section of the second thermal resistance material layer cooperate to establish the thermal insulating material insert.

In a further non-limiting embodiment of any of the foregoing traction battery packs, a stepped section of the first thermal resistance material layer or the second thermal resistance material layer establishes the thermal insulating material insert.

A traction battery pack according to another exemplary aspect of the present disclosure includes, among other things, a thermal barrier assembly arranged to partition a battery cell stack into a first compartment and a second compartment. The thermal barrier assembly includes a thermal fin and a thermal insulating material insert positioned within a void space of the thermal fin.

In a further non-limiting embodiment of the forgoing traction battery pack, the thermal fin is made of aluminum, and the thermal insulating material insert is made of mica.

In a further non-limiting embodiment of either of the foregoing traction battery packs, the first compartment and the second compartment establish separate coolant flow passages for receiving an immersion coolant.

In a further non-limiting embodiment of any of the foregoing traction battery packs, the thermal fin is sandwiched between a first thermal resistance material layer and a second thermal resistance material layer of the thermal barrier assembly.

In a further non-limiting embodiment of any of the foregoing traction battery packs, a first stepped section of the first thermal resistance material layer and a second stepped section of the second thermal resistance material layer cooperate to establish the thermal insulating material insert.

In a further non-limiting embodiment of any of the foregoing traction battery packs, the first stepped section includes a first thickness that is greater than a second thickness of a remaining section of the first thermal resistance material layer.

In a further non-limiting embodiment of any of the foregoing traction battery packs, the first thermal resistance material layer and the second thermal resistance material layer are each mica sheets.

In a further non-limiting embodiment of any of the foregoing traction battery packs, the thermal barrier assembly further comprises a first adhesive layer between the thermal fin and the first thermal resistance material layer and a second adhesive layer between the thermal fin and the second thermal resistance material layer.

In a further non-limiting embodiment of any of the foregoing traction battery packs, the thermal insulating material insert fills the void space of the thermal fin.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle having a traction battery pack.

FIG. 2 illustrates an exemplary battery array of a traction battery pack.

FIG. 3 is a cross-sectional view through section 3-3 of the battery array of FIG. 2.

FIG. 4 illustrates an exemplary thermal barrier assembly.

FIG. 5 is an exploded view of the thermal barrier assembly of FIG. 4.

FIG. 6 is a cross-sectional view through section 6-6 of the thermal barrier assembly of FIG. 4.

FIG. 7 is a sectional view of another exemplary thermal barrier assembly.

FIG. 8 is a sectional view of yet another exemplary thermal barrier assembly.

### DETAILED DESCRIPTION

This disclosure details thermal barrier assembly designs for use within traction battery packs. An exemplary traction battery pack may include a battery array having a cell stack housed within an array housing. The cell stack may include one or more thermal barrier assemblies arranged between adjacent battery cells of the cell stack. Each thermal barrier assembly may include a thermal fin and a thermal resistance material insert received within a void space of the thermal fin, thereby increasing the amount of thermal insulation across a conduction path of the cell stack without increasing the overall thickness of the thermal barrier assembly. A surface area ratio of the insert relative to the thermal fin can be tuned to balance the respective amounts of thermal insulation and thermal conductivity provided by the thermal barrier assembly. These and other features are discussed in greater detail in the following paragraphs of this detailed description.

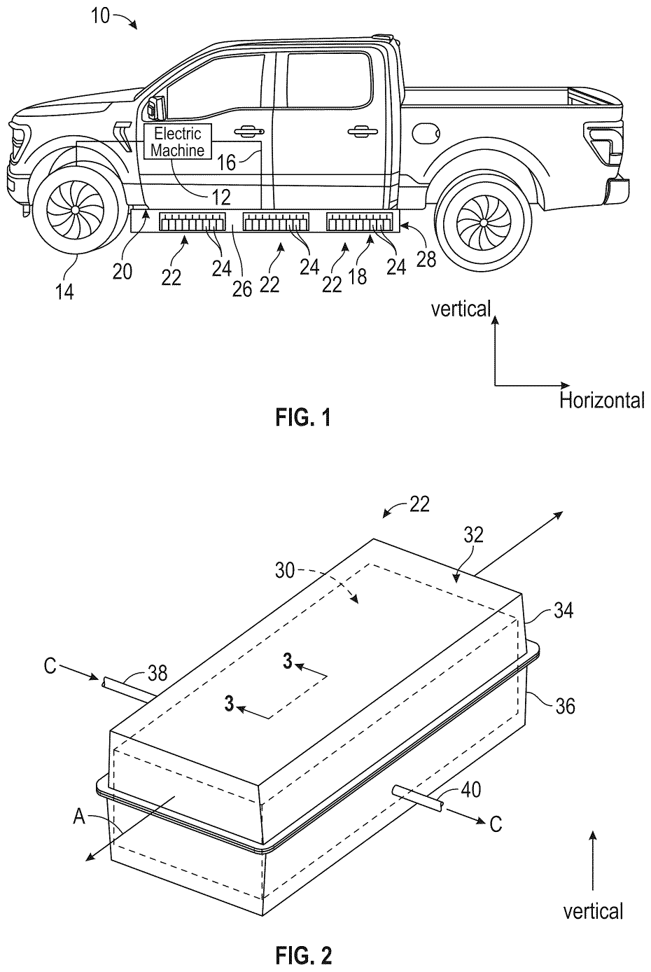

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering the various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, lithium manganese rich, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

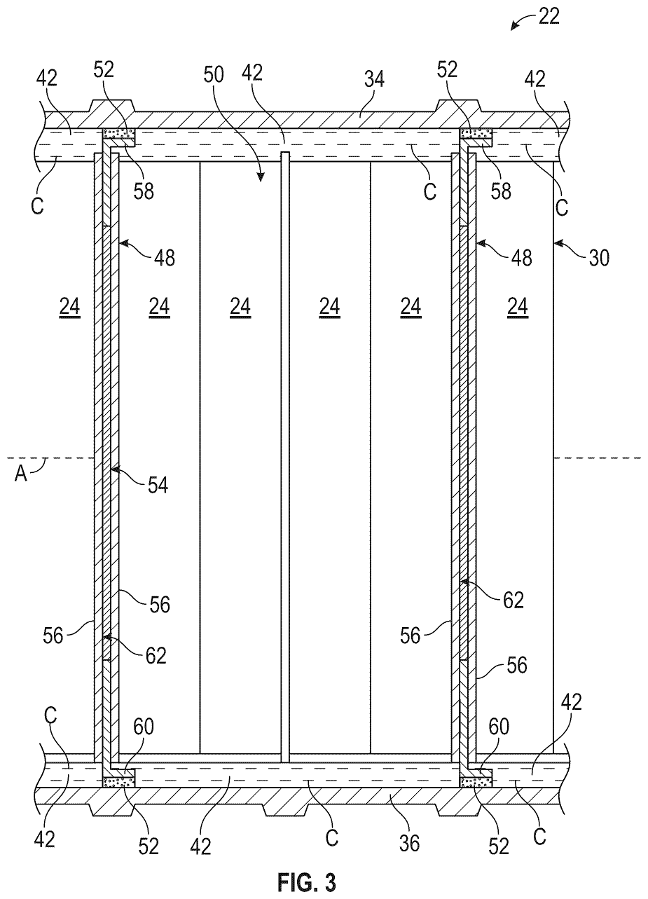

FIGS. 2-3 illustrate features associated with a battery array 22 of a traction battery pack. For example, the traction battery pack 18 of the electrified vehicle 10 of FIG. 1 could include one or more battery arrays having a design substantially similar to that of the battery array 22 shown in FIG. 2.

The battery array 22 may include one or more cell stacks 30 housed inside an array housing 32. The array housing 32 may include a top cover 34 and a bottom cover 36, which may both be tray-like structures. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are referenced relative to the general orientation of the traction battery pack 18 when installed on the electrified vehicle 10 of FIG. 1. Vertical, for purposes of this disclosure, is also with reference to ground and the manner the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 could vary within the scope of this disclosure.

The cell stack 30 may include a plurality of the battery cells 24. Thermal energy levels of the battery cells 24 of the battery array 22 can increase as the electrified vehicle 10 is operated. A thermal management system can therefore be employed for managing the thermal energy levels of the battery cells 24 of the battery array 22. The thermal management system may be configured to route a coolant C through the interior of the array housing 32 of the battery array 22 in order to manage the thermal energy levels of the battery array 22 by, for example, using the coolant C to take on and carry away thermal energy from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22.

The thermal management system can deliver the coolant C to the interior of the battery array 22 through an inlet 38 of the array housing 32. The coolant C can fill one or more open areas (see, e.g., compartments 42, which are best shown in FIG. 3) inside the battery array 22 such that the battery cells 24 are directly contacted by the coolant C. The coolant C can take on thermal energy from the battery cells 24 for managing the thermal energy levels of the battery array 22. The coolant C may exit the battery array 22 through an outlet 40 of the array housing 32. In an embodiment, both the inlet 38 and the outlet 40 are provided through the bottom cover 36 of the array housing 32. However, other inlet 38 and/or outlet 40 locations are contemplated within the scope of this disclosure.

The coolant C exiting the battery array 22 through the outlet 40 can move to a thermal energy exchange device (not shown), such as a heat exchanger, for example, where thermal energy can be transferred from the coolant C to atmosphere. A pump (not shown) can be operated to selectively circulate the coolant C between the battery array 22 and the thermal energy exchange device and then back to the battery array 22 as part of a closed-loop system.

The coolant C circulated in the immersion thermal management system may be a dielectric fluid or another type of non-electrically conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, thermal conductivity, etc.) may vary depending on the environment the battery array 22 is to be utilized, among various other factors.

The battery cells 24 of the cell stack 30 may be arranged together along a cell stack axis A. Although a single cell stack 30 having a specific number of battery cells 24 is illustrated in the figures of this disclosure, the battery array 22 could include any number of cell stacks 30, with each cell stack 30 having any number of individual battery cells 24.

Referring now primarily to FIG. 3, a plurality of thermal barrier assemblies 48 can be interspersed along the cell stack axis A between adjacent battery cells 24 of the cell stack 30. The thermal barrier assemblies 48 may be configured to interface with the array housing 32 for compartmentalizing the battery array 22 into multiple compartments 42. Each compartment 42 may establish a dedicated coolant flow passage for directing the coolant C through the battery array 22 as part of the immersion thermal management system described above.

Each compartment 42 may house a cell packet 50, which is a subgrouping of the plurality of battery cells 24 of the cell stack 30. Each cell packet 50 may be disposed between adjacent pairs of the thermal barrier assemblies 48 of the cell stack 30. In an embodiment, each cell packet 50 includes four battery cells 24. However, other configurations are contemplated within the scope of this disclosure, and it should be evident to persons of ordinary skill in the art having the benefit of this disclosure that the cell stack 30 could include any amount and arrangement of battery cells 24, thermal barrier assemblies 48, cell packets 50, etc.

Each thermal barrier assembly 48 may include a thermal fin 54, which may be made of a metallic material such as aluminum, for example, that is flanked by additional layers 56 (best seen in FIGS. 3-6), such as thermal resistance material layers, for example, as part of a multi-layered sandwich structure. The thermal barrier assemblies 48 may therefore include a combination of metallic materials and thermally insulating materials, such as high temperature resistance thermoplastic or thermoset composites, aerogel materials, or mica materials, for example.

In an embodiment, the thermal fin 54 of each thermal barrier assembly 48 includes a C-shaped design. However, other cross-sectional shapes are contemplated within the scope of this disclosure.

Each thermal fin 54 may include an upper fin portion 58, a lower fin portion 60, and a mid-fin portion 62 extending between the upper fin portion 58 and the lower fin portion 60. The upper fin portion 58 and the lower fin portion 60 may each be configured as a flange that extends at a transverse angle (e.g., about perpendicular) from the mid-fin portion 62. The upper fin portion 58 may be configured to interface with the top cover 34 of the array housing 32, the lower fin portion 60 may be configured to interface with the bottom cover 36 of the array housing 32, and the mid-fin portion 62 of each thermal fin 54 may be positioned axially between battery cells 24 of adjacently located cell packets 50 of the cell stack 30.

The upper fin portions 58 of the thermal fins 54 may extend above the battery cells 24 of the cell stack 30, and the lower fin portions 60 of the thermal fins 54 may extend below the battery cells 24 of the cell stack 30. The thermal fins 54 therefore aid in establishing the compartments 42. Should, for example, a battery thermal event occur in one of the compartments 42, the thermal barrier assemblies 48 can reduce or even prevent thermal energy associated with the thermal event from moving from cell-to-cell, compartment-to-compartment, and/or cell stack-to-cell stack, thereby inhibiting the transfer of thermal energy inside the battery array 22. Moreover, due to the increased contact with the array housing 32 achieved by the upper fin portions 58 and the lower fin portions 60, the thermal barrier assemblies 48 can provide increased thermal transfer mitigation performance by directing a greater amount of heat transfer into the array housing 32 via thermal conduction.

An adhesive 52 may be utilized to secure the upper fin portions 58 to the top cover 34 of the array housing 32 and to secure the lower fin portions 60 to the bottom cover 36 of the array housing 32, thereby structurally integrating the battery array 22 in a manner that increases its rigidity/stiffness. The adhesive 52 may be a structural adhesive, such as an epoxy based adhesive or a urethane based adhesive, for example. However, other types of adhesives are contemplated within the scope of this disclosure.

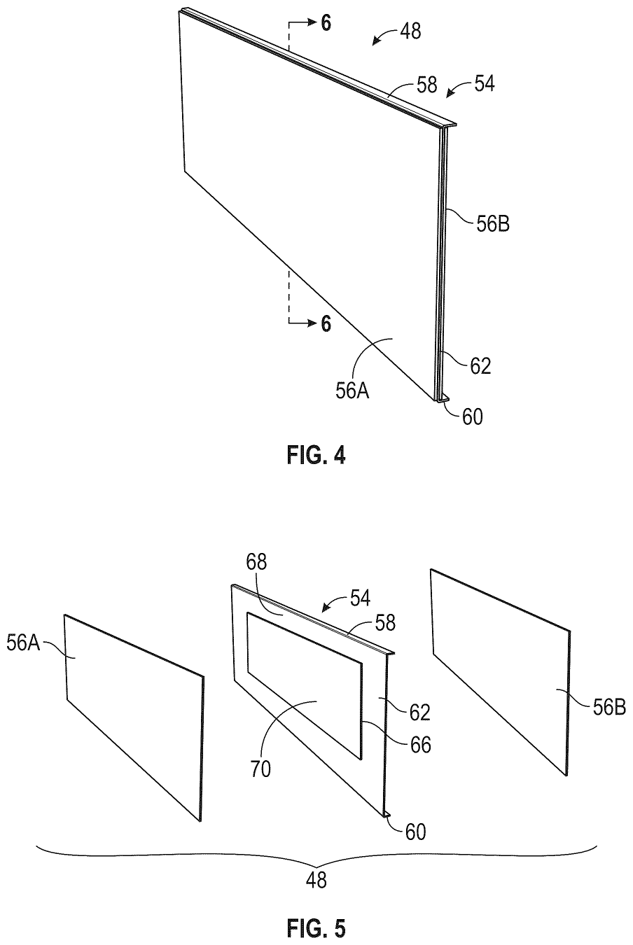

FIGS. 4-6 illustrate an exemplary thermal barrier assembly 48 that can be employed for use within the cell stack 30 of the battery array 22 discussed above for mitigating the transfer of thermal energy across a conduction path of the cell stack 30. The thermal barrier assembly 48 may include a thermal fin 54, a first thermal resistance material layer 56A, and a second thermal resistance material layers 56B. The thermal fin 54 of the thermal barrier assembly 48 may be sandwiched between the first thermal resistance material layer 56A and the second thermal resistance material layer 56B. In an embodiment, the thermal fin 54 is an aluminum fin, and the first and second thermal resistance material layers 56A, 56B are both mica sheets. However, other materials or combinations of materials are contemplated within the scope of this disclosure.

A void space 66 may be formed through the mid-fin portion 62 of the thermal fin 54. The void space 66 may be a through-opening that is formed (e.g., stamped) through the mid-fin portion 62. A solid section 68 of the mid-fin portion 62 may circumscribe the void space 66. In an embodiment, the void space 66 is rectangular shaped. However, other shapes are contemplated within the scope of this disclosure.

A thermal resistance material insert 70 may be received within the void space 66. The thermal resistance material insert 70 may be an additional mica sheet, for example. In an embodiment, the thermal resistance material insert 70 completely fills the void space 66. However, the respective sizes of the void space 66 and the thermal resistance material insert 70 could vary depending on various factors, including but not limited to the required rigidity of the thermal fin 54. By leveraging the void space 66 of the thermal fin 54 for packaging the thermal resistance material insert 70, the amount of thermal insulation provided by the thermal barrier assembly 48 along the conduction path of the cell stack 30 can be increased without increasing an overall thickness T (e.g., measured in a direction of the cell stack axis A) of the thermal barrier assembly 48. The proposed barrier design can therefore facilitate optimized packageability of the cell stacks 30 and battery arrays 22 within the traction battery pack 18.

In another embodiment, a surface area ratio of the thermal resistance material insert 70 relative to the thermal fin 54 can be tuned to balance the respective amounts of thermal insulation and thermal conductivity provided by the thermal barrier assembly 48. In some implementations, the surface area ratio of the thermal resistance material insert 70 relative to the thermal fin 54 may be between about 20% and about 50% (e.g., the thermal resistance material insert 70 occupies between about 20% and about 50% of the total surface area of the thermal fin 54). However, the actual surface area ratio of the thermal resistance material insert 70 relative to the thermal fin 54 may depend on factors such as battery cell chemistry, expected thermal propagation dynamics, etc.

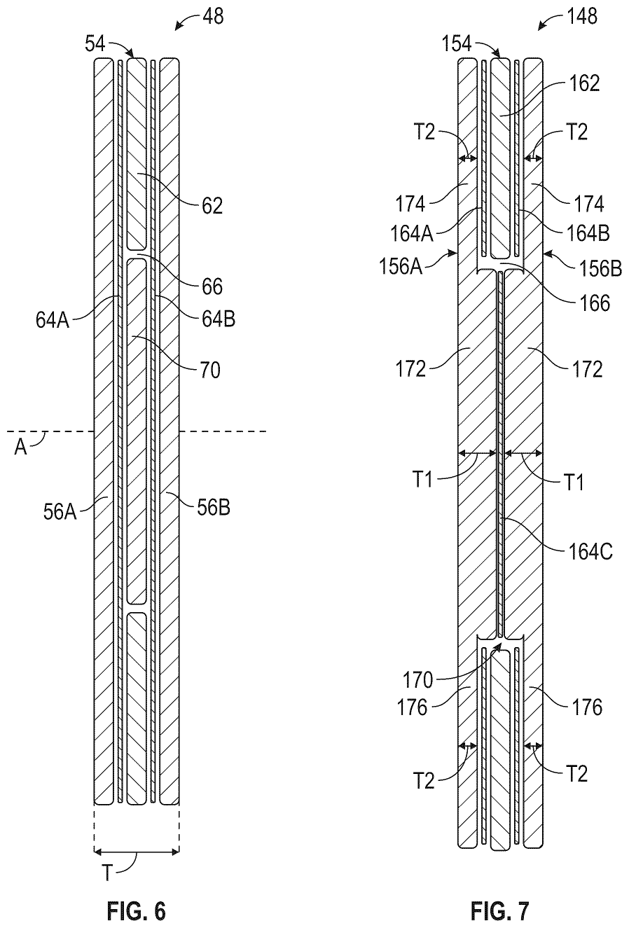

The thermal barrier assembly 48 may additionally include a first adhesive layer 64A and a second adhesive layer 64B (see FIG. 6). The first adhesive layer 64A may be applied between the thermal fin 54 and the first thermal resistance material layer 56A, and the second adhesive layer 64B may be applied between the thermal fin 54 and the second thermal resistance material layer 56B. The first adhesive layer 64A may therefore extend axially between the first thermal resistance material layer 56A and each of the mid-fin portion 62 of the thermal fin 54 and the thermal resistance material insert 70, and the second adhesive layer 64B may therefore extend axially between the second thermal resistance material layer 56B and each of the mid-fin portion 62 of the thermal fin 54 and the thermal resistance material insert 70.

The first and second adhesive layers 64A, 64B may be a structural adhesive, such as an epoxy based adhesive or a urethane based adhesive, for example. However, other types of adhesives are contemplated within the scope of this disclosure.

FIG. 7 illustrates another exemplary thermal barrier assembly 148 that can be employed for use within the cell stack 30 of the battery array 22 discussed above. The thermal barrier assembly 148 may include a thermal fin 154, a first thermal resistance material layer 156A, and a second thermal resistance material layers 156B. The thermal fin 154 of the thermal barrier assembly 148 may be sandwiched between the first thermal resistance material layer 156A and the second thermal resistance material layer 156B. In an embodiment, the thermal fin 154 is an aluminum fin, and the first and second thermal resistance material layers 156A, 156B are mica sheets. However, other materials or combinations of materials are contemplated within the scope of this disclosure.

A void space 166 may be formed through a mid-fin portion 162 of the thermal fin 154. The void space 166 may be a through-opening that is formed (e.g., stamped) through the mid-fin portion 162.

The first thermal resistance material layer 156A and the second thermal resistance material layer 156B may each include a non-uniform thickness by virtue of incorporating a stepped design. For example, the first thermal resistance material layer 156A and the second thermal resistance material layer 156B may each include a stepped section 172 that is flanked by both an upper section 174 and a lower section 176 of the respective thermal resistance material layer. Each stepped section 172 may include a first thickness T1 that is larger than a second thickness T2 of the upper section 174 and the lower section 176. The first thermal resistance material layer 156A and the second thermal resistance material layer 156B are therefore each “thickened” at their mid-portions.

The stepped section 172 of each of the first thermal resistance material layer 156A and the second thermal resistance material layer 156B may extend into the void space 166 of the thermal fin 154. The stepped sections 172 may cooperate to substantially fill the void space 166 for establishing a thermal resistance material insert 170 of the thermal barrier assembly 148. By leveraging the void space 166 of the thermal fin 154 for packaging the thermal resistance material insert 170, the amount of thermal insulation provided by the thermal barrier assembly 148 along a conduction path of the cell stack 30 can be increased without increasing an overall thickness T (e.g., measured in a direction of the cell stack axis A) of the thermal barrier assembly 148. The proposed barrier design can therefore facilitate optimized packageability of the cell stacks 30 and battery arrays 22 within the traction battery pack 18.

The thermal barrier assembly 148 may additionally include a first adhesive layer 164A, a second adhesive layer 164B, and a third adhesive layer 164C. The first adhesive layer 164A may be applied between the thermal fin 154 and the first thermal resistance material layer 156A, the second adhesive layer 164B may be applied between the thermal fin 154 and the second thermal resistance material layer 156B, and the third adhesive layer 164C may be applied between the stepped section 172 of the first thermal resistance material layer 156A and the stepped section 172 of the second thermal resistance material layer 156B.

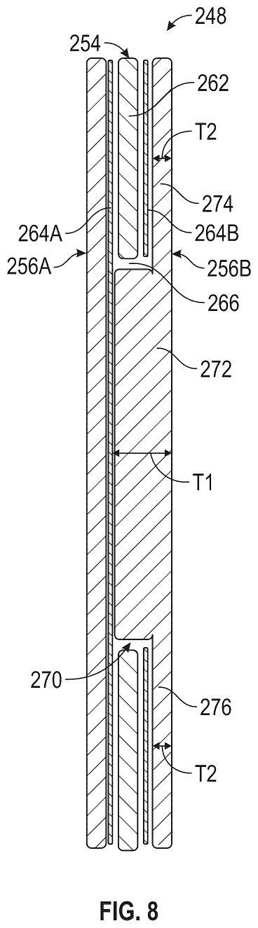

FIG. 8 illustrates another exemplary thermal barrier assembly 248 that can be employed for use within the cell stack 30 of the battery array 22 discussed above. The thermal barrier assembly 248 may include a thermal fin 254, a first thermal resistance material layer 256A, and a second thermal resistance material layers 256B. The thermal fin 254 of the thermal barrier assembly 248 may be sandwiched between the first thermal resistance material layer 256A and the second thermal resistance material layer 256B. In an embodiment, the thermal fin 254 is an aluminum fin, and the first and second thermal resistance material layers 256A, 256B are mica sheets. However, other materials or combinations of materials are contemplated within the scope of this disclosure.

A void space 266 may be formed through a mid-fin portion 262 of the thermal fin 254. The void space 266 may be a through-opening that is formed (e.g., stamped) through the mid-fin portion 262.

In this embodiment, the first thermal resistance material layer 256A may include a uniform thickness, whereas the second thermal resistance material layer 256B may include a non-uniform thickness by virtue of incorporating a stepped design. For example, the second thermal resistance material layer 256B may include a stepped section 272 that is flanked by both an upper section 274 and a lower section 276 of the second thermal resistance material layer 256B. The stepped section 272 may include a first thickness T1 that is larger than a second thickness T2 of the upper section 274 and the lower section 276. The second thermal resistance material layer 256B is therefore “thickened” at its mid-portion.

The stepped section 272 of the second thermal resistance material layer 256B may extend into the void space 266 of the thermal fin 154. The stepped section 272 may substantially fill the void space 266 for establishing a thermal resistance material insert 270 of the thermal barrier assembly 248. By leveraging the void space 266 of the thermal fin 254 for packaging the thermal resistance material insert 270, the amount of thermal insulation provided by the thermal barrier assembly 248 along a conduction path of the cell stack 30 can be increased without increasing an overall thickness T (e.g., measured in a direction of the cell stack axis A) of the thermal barrier assembly 248. The proposed barrier design can therefore facilitate optimized packageability of the cell stacks 30 and battery arrays 22 within the traction battery pack 18.

The thermal barrier assembly 248 may additionally include a first adhesive layer 264A and a second adhesive layer 264B. The first adhesive layer 264A may be applied between the thermal fin 254 and the first thermal resistance material layer 256A and between the stepped section 272 and the first thermal resistance material layer 256A, and the second adhesive layer 264B may be applied between the thermal fin 254 and the second thermal resistance material layer 256B.

The exemplary thermal barrier assemblies of this disclosure include an insulating insert packaged within a void space of a thermal fin of the thermal barrier assembly. The proposed designs can therefore provide for increased thermal insulation in an overall thinner package.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery pack, comprising:
a first battery cell;
a second battery cell; and
a thermal barrier assembly arranged between the first battery cell and the second battery cell, the thermal barrier assembly including a thermal fin and a thermal insulating material insert received within a void space of the thermal fin.

2. The battery pack as recited in claim 1, wherein the first battery cell, the second battery cell, and the thermal barrier assembly are housed inside a housing that includes a top cover and a bottom cover.

3. The battery pack as recited in claim 2, wherein an upper fin portion of the thermal fin is fixedly secured to the top cover by an adhesive.

4. The battery pack as recited in claim 2, wherein a lower fin portion of the thermal fin is fixedly secured to the bottom cover by an adhesive.

5. The battery pack as recited in claim 1, wherein the thermal barrier assembly separates a first compartment where the first battery cell resides from a second compartment where the second battery cell resides.

6. The battery pack as recited in claim 5, wherein the first compartment and the second compartment establish separate coolant flow passages for receiving an immersion coolant.

7. The battery pack as recited in claim 1, wherein the thermal insulating material insert is a mica insert.

8. The battery pack as recited in claim 1, wherein the thermal insulating material insert fills the void space of the thermal fin.

9. The battery pack as recited in claim 1, wherein the thermal fin is sandwiched between a first thermal resistance material layer and a second thermal resistance material layer.

10. The battery pack as recited in claim 9, wherein a first stepped section of the first thermal resistance material layer and a second stepped section of the second thermal resistance material layer cooperate to establish the thermal insulating material insert.

11. The battery pack as recited in claim 9, wherein a stepped section of the first thermal resistance material layer or the second thermal resistance material layer establishes the thermal insulating material insert.

12. A battery pack, comprising:
a thermal barrier assembly arranged to partition a battery cell stack into a first compartment and a second compartment; and
the thermal barrier assembly including a thermal fin and a thermal insulating material insert positioned within a void space of the thermal fin.

13. The battery pack as recited in claim 12, wherein the thermal fin is comprised of aluminum, and the thermal insulating material insert is comprised of mica.

14. The battery pack as recited in claim 12, wherein the first compartment and the second compartment establish separate coolant flow passages for receiving an immersion coolant.

15. The battery pack as recited in claim 12, wherein the thermal fin is sandwiched between a first thermal resistance material layer and a second thermal resistance material layer of the thermal barrier assembly.

16. The battery pack as recited in claim 15, wherein a first stepped section of the first thermal resistance material layer and a second stepped section of the second thermal resistance material layer cooperate to establish the thermal insulating material insert.

17. The battery pack as recited in claim 16, wherein the first stepped section includes a first thickness that is greater than a second thickness of a remaining section of the first thermal resistance material layer.

18. The battery pack as recited in claim 15, wherein the first thermal resistance material layer and the second thermal resistance material layer are each mica sheets.

19. The battery pack as recited in claim 15, wherein the thermal barrier assembly further comprises a first adhesive layer between the thermal fin and the first thermal resistance material layer and a second adhesive layer between the thermal fin and the second thermal resistance material layer.

20. The battery pack as recited in claim 12, wherein the thermal insulating material insert fills the void space of the thermal fin.
